(19) United States
(12) Patent Application Publication
(10) Pub. No.: US 2013/0126637 A1
(43) Pub. Date: May 23, 2013

(54) ATOMIZER WITH LIQUID SUPPLEMENT CONTAINER

(71) Applicant: MICRO BASE TECHNOLOGY CORPORATION, Bade City (TW)

(72) Inventors: SHU-PIN HSIEH, BADE CITY (TW); TUN-YING FANG, BADE CITY (TW); YU-CHUNG HSU, BADE CITY (TW); TAI-SHUAN LIN, BADE CITY (TW); CHIA-CHEN HUANG, BADE CITY (TW); HSIANG-YUAN LAI, BADE CITY (TW)

(73) Assignee: MICRO BASE TECHNOLOGY CORPORATION, BADE CITY (TW)

(21) Appl. No.: 13/672,709

(22) Filed: Nov. 9, 2012

(30) Foreign Application Priority Data
Nov. 11, 2011 (TW) 100221342

(51) Int. Cl. B05B 17/00

(52) U.S. Cl. CPC B05B 17/0646
USPC 239/102.2; 239/309

(57) ABSTRACT

In an atomizer with a liquid supplement container, the atomizer includes a casing and an atomization device covered by the casing, and the container is filled with a supplementary liquid and has a seal disposed at an opening of the container for easy storage and carry. The casing further includes at least one installing slot, and a seal destruction structure installed in the installing slot, and the installing slot is coupled with the atomization device. When the container is installed in the installing slot, the seal destruction structure destruct the seal to allow the supplementary liquid to flow into the installing slot for the atomization by the atomization device, so as to improve the convenience of use, prevent the supplementary liquid from contaminating the casing or causing failure of the atomization device.

### BACKGROUND OF THE INVENTION

1. Field of the Invention

The present invention relates to the technical field of liquid atomization devices, and more particularly to an atomizer with a liquid supplement container that has the features of easy storage and carry as well as convenient replacement and installation.

2. Description of the Related Art

As industry and commerce advance, people enjoy a rich material life while being troubled by some of the changes occurred in our living environment. For example, we spend much time in an air-conditioned environment and may have diseases of our respiratory system easily. To improve such problem, aromatherapy which is a natural therapy invented by Ancient Egypt is adopted. The aromatherapy uses an essential oil extracted from an aromatic plant as a medium and the essential oil is absorbed into a user's body from the user's respiratory tract or skin by massage, bath or aromatherapy in order to achieve the effects of relieving pressure and improving health. The main principle of aromatherapy is to use the essential oil of a plant such as lavender, lemon, lemongrass or rose or water that may be mixed with other medicines and distribute the aerosol essential oil into the air to produce an aromatic odor to achieve the effects of removing bad smells, relieving pressure and providing a medical treatment.

At present, aromatherapy generally uses an essential oil lamp to burn the essential oil in order to disperse molecules of the essential oil into the air, but there is a risk of causing fire or explosion. In addition, there is another electronic essential oil diffuser that uses oscillations of an electronic device to atomize a liquid essential oil quickly into small molecules and blow the molecules to disperse the aromatic odor of the essential oil in a short time and expand the dispersion range effectively, so that the electronic essential oil diffuser is the best choice for aromatherapy. Such essential oil diffuser is further developed into a device having an the effect of a cosmetic spray or a medial spray, and such device sprays liquid mist with the cosmetic effect onto a user's skin, and molecules of the atomized liquid can be absorbed quickly through the user's skin to achieve the cosmetic effect. Similarly, a solution with the cosmetic effect can be replaced by a solution with the medical effect and then the solution is sprayed to achieve the effect of the desired medical treatment. The solution can be absorbed through respiration, and thus most devices with a medical treatment effect refer to an application for respiratory treatment and are used to replace the conventional respiratory devices that spray relatively larger powder or atomized particles in order to achieve a better medical treatment effect for patients with diseases of the respiratory tract.

However, the conventional aromatherapy diffuser generally uses an atomization liquid (including both cosmetic liquid and medical liquid) with the content of an essential oil, water or a volatile solution. The atomization liquids of this sort have a concentration controlled to an appropriate level and stored properly to assure the expected effect and prevent a change of the concentration of the atomization liquid caused by vaporization. Regardless of the issues of volume and portability, most aromatherapy diffusers available in the market come with a device body, an atomization device and a liquid supplement container, or a design having the device body, the atomization device and the liquid supplement container integrally formed with one another. The atomization liquid is filled and stored in an external bottle first and then added into the liquid supplement container for use. Further, there is another design with the atomization device and the liquid supplement container integrally formed and a device body separated, wherein the atomization liquid is added into the liquid supplement container directly. Further, there is another design with the device body and the atomization device integrally formed and the liquid supplement container separated, wherein the atomization liquid is added into the liquid supplement container first, and then the liquid supplement container is combined with the device body.

However, the aforementioned three designs still have the following drawbacks:

1. When the atomization liquid is added, the atomization liquid may flow out easily, thus causing unnecessary waste, and repeated replacements may cause issues of storage and surface contamination.

2. The device body may break down caused by an overflow of the atomization liquid.

3. An additional container is required for filling the liquid, thus causing inconvenience of use.

In view of the aforementioned drawbacks, the inventor of the present invention discloses an atomizer with a liquid supplement container, wherein a supplementary liquid is filled into the container and a seal is formed at an opening of the container and comes with a disposable design that features easy storage and convenient carry. The inventor of the present invention further comprises a seal destruction structure for destructing the seal section by section, such that the seal can be cut open during the assembling or use, so as to achieve the effects of destructing the seal by bursting or any other equivalent method, and allowing the supplementary liquid to flow into the installing slot successfully for atomization and use. The present invention can improve the convenience of use and overcome the drawbacks of the prior art.

### SUMMARY OF THE INVENTION

Therefore, it is a primary objective of the present invention to provide an atomizer with a liquid supplement container, wherein after a seal destruction structure and a disposable container are combined with each other, the supplementary liquid can flow into the container successfully for atomization and use, so as to improve the convenience of use.

Another objective of the present invention is to provide an atomizer with a liquid supplement container, wherein the container comes with a disposable design and has the advantages of easy storage and convenient carry.

A further objective of the present invention is to provide an atomizer with a liquid supplement container, wherein the casing and the container are coupled by screwing or latching, so that when the casing and the container are combined by rotation or pushing, the assembly will not be loosened or detached easily.

To achieve the aforementioned objective, the present invention provides an atomizer with a liquid supplement container, characterized in that the container is filled with a supplementary liquid, and has a seal disposed at an opening of the liquid supplement container; the atomizer, comprises:

a casing, having a containing space defined therein, at least one installing slot formed on the casing and interconnected with the containing space, and a seal destruction structure installed in the installing slot; and

an atomization device, installed in the containing space of the casing, and having at least one spray hole formed on a surface of the casing for atomizing the supplementary liquid and spraying the supplementary liquid out from the spray hole.

Wherein, the atomization device comprises a spray-hole plate, a piezoelectric plate and a driving circuit board, and the spray-hole plate is installed on a side of the containing space and at a position proximate to the spray hole, and the piezoelectric plate is disposed on the other side of the spray-hole plate, and the driving circuit board is electrically coupled to the piezoelectric plate for driving an operation of the piezoelectric plate.

When the container is installed in the installing slot, the seal destruction structure destructs the seal by bursting or cutting or a combination thereof, so that the supplementary liquid can flow into the installing slot successfully for atomization and use by the atomization device. In addition, the seal has at least one pair of pre-cut lines formed thereon and intersected with one another.

In a preferred embodiment, the container is made of glass, plastic or metal, and the seal is a sealing film made of paper, metal, silicone or plastic, and the container comes with a disposable design and provides an easy storage of the supplementary liquid and a convenient carry of the container.

In a preferred embodiment, the seal destruction structure comprises at least one push rod, at least one cut portion and a combination of both. In addition, the push rod is installed at a center position or a bias position of the installing slot for bursting or propping open the seal. The cut portion has a plurality of pointed teeth arranged discontinuously and with an interval apart from one another, or the pointed teeth are arranged adjacent to one another to form a ring-shaped structure, and the cut portion is integrally formed in the installing slot. In addition, the cut portion can also be manufactured into a separate ring-shaped structure, and the pointed teeth can be in a triangular shape, a rectangular shape, a conical shape, a thin-plate shape or a protruding-column shape, and the pointed teeth are arranged with equal heights or unequal heights with increasingly greater heights.

In a preferred embodiment, the container has a first thread portion disposed outside the container and provided for screwing to a second thread portion of the installing slot internal wall, so as to integrally combine the first and second thread portions, or the container has at least one pair of latches disposed outside the container for latching into internal walls of at least one pair of latching portions of the installing slot, and each latching portion has a guide slot disposed at a position corresponding to each respective latch, and provided for latching a protrusion of the latch therein, so as to slidably combine the protrusion with the guide slot by a sliding latch. The container has at least one pair of bumps disposed outside the container for slidably latching into at least one pair of arc-shaped guide slots formed on an internal wall of the installing slot, so as to combine the bumps with the guide slots integrally. With the aforementioned assembling method, the seal destruction structure can destruct the seal to allow the supplementary liquid to flow into the installing slot for atomization and use by the atomization device.

### BRIEF DESCRIPTION OF THE DRAWINGS

FIG. 1 is an exploded view of a preferred embodiment of the present invention;

FIG. 2 is a perspective view of a preferred embodiment of the present invention;

FIG. 3 is a cross-sectional view of a preferred embodiment of the present invention;

FIG. 4 is a schematic view of a first implementation mode of a preferred embodiment of the present invention;

FIG. 5A is a first schematic view of a second implementation mode of a preferred embodiment of the present invention;

FIG. 5B is a second schematic view of the second implementation mode of a preferred embodiment of the present invention;

FIG. 6 is a schematic view of a third implementation mode of a preferred embodiment of the present invention;

FIG. 7 is a schematic view of a fourth implementation mode of a preferred embodiment of the present invention;

FIG. 8 is a schematic view of a fixation method of a preferred embodiment of the present invention;

FIG. 9 is a schematic view of a fixation method of a preferred embodiment of the present invention;

FIG. 10 is a schematic view of another fixation method of a preferred embodiment of the present invention; and

FIG. 11 is a schematic view of a sealing method of a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

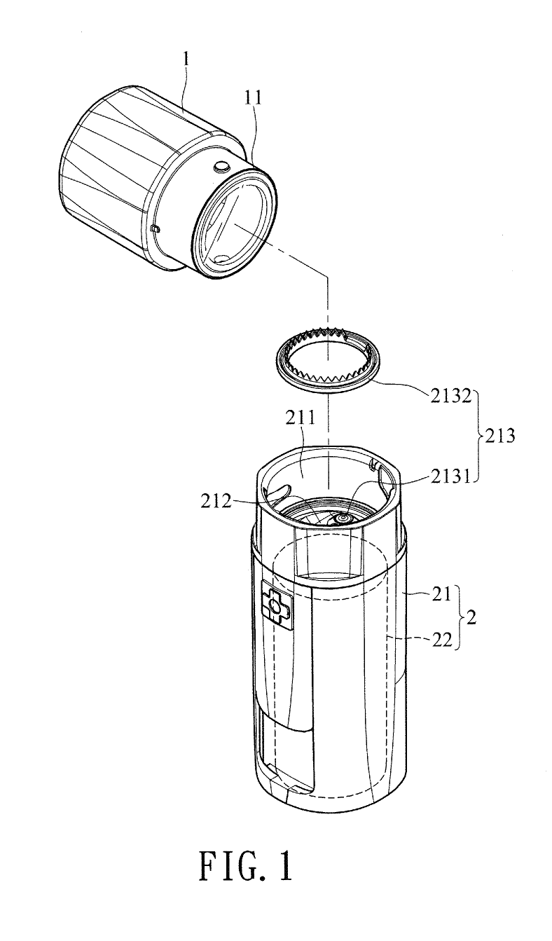

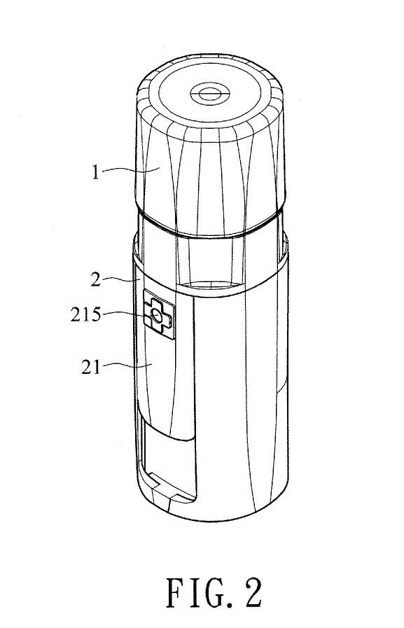

With reference to FIGS. 1 to 3 for an exploded view, a perspective view and a cross-sectional view of an atomizer with a liquid supplement container in accordance with a preferred embodiment of the present invention respectively, the present invention comprises at least one container 1 and an atomizer 2 corresponding to the container 1.

The container 1 is filled with a supplementary liquid 3, and the container 1 has a seal 11 disposed at an opening of the container 1, and the prepared supplementary liquid 3 is sealed into the container 1 to provide a better storage effect. In addition, the container 1 is made of glass, plastic, ceramic or metal. It is noteworthy that the container 1 of the present invention adopts a disposable design, but the material used for making the container 1 can be recycled and reused to minimize the waste of materials. The seal 11 is made of paper, a metal film, a silicone film or a plastic film for a different storage effect.

The atomizer 2 is comprised of two parts including a casing 21 and an atomization device 22, and the casing 21 includes a containing space 211 defined therein, at least one installing slot 212 formed on the casing and 21 interconnected with the containing space 211, and a seal destruction structure 213 installed in the installing slot 212, and the atomization device 22 is installed in the containing space 211 of the casing 21, and a spray hole 215 is formed on a surface of the casing 21 for atomizing the supplementary liquid 3 and spraying the supplementary liquid 3 out from the spray hole 215. In addition, the atomization device 22 further comprises a spray-hole plate 221, a piezoelectric plate 222 and a driving circuit board 223, wherein the spray-hole plate 221 is installed on a side inside the containing space 211 and proximate to the spray hole 215, and the spray-hole plate 221 has a plurality of holes (not shown in the figure) formed thereon, and the piezoelectric plate 222 is disposed on the spray-hole plate 221, and the driving circuit board 223 is electrically coupled to the piezoelectric plate 222 for driving the operation of the piezoelectric plate 222 to produce high-speed vibrations, and the spray-hole plate 221 is combined to atomize the supplementary liquid 3 sufficiently and spray the supplement liquid 3 out from the spray hole 215.

It is noteworthy that the present invention provides different ways of destructing the seal 11 including bursting, cutting, propping open, or a combination thereof, and thus different types of seal destruction structures 213 are disclosed. With reference to FIG. 1 for the best mode of the present invention, the seal destruction structure 213 comprises a push rod 2131 and a cut portion 2132 combined into the installing slot 212, wherein the push rod 2131 is installed at a bias position of the installing slot 212 for bursting the seal 11. However, the installation position of the push rod 2131 is not limited to such position only, but the push rod 2131 can also be installed at the center position (not shown in the figure) of the installing slot 212. In addition, at least one pair of pre-cut lines is formed on the seal 11 and intersected with each other to form an X-shape. Since the thickness where the pair of pre-cut lines is situated is thinner, therefore the push rod 2131 can burst the seal 11 easily. In addition, the cut portion 2132 has a plurality of pointed teeth, each being in a triangular shape, a rectangular shape, a conical shape, a thin-plate shape or a protruding-column shape, and the pointed teeth are arranged adjacent to one another to form a ring-shaped structure and integrally formed inside the installing slot 212 or installed in the installing slot 212 with a separate design.

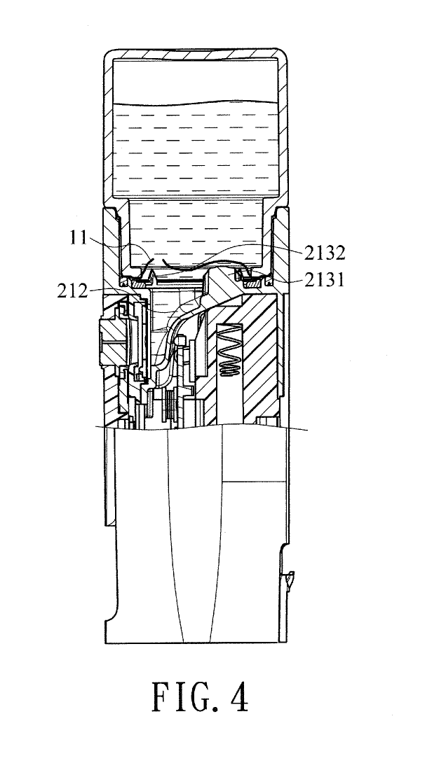

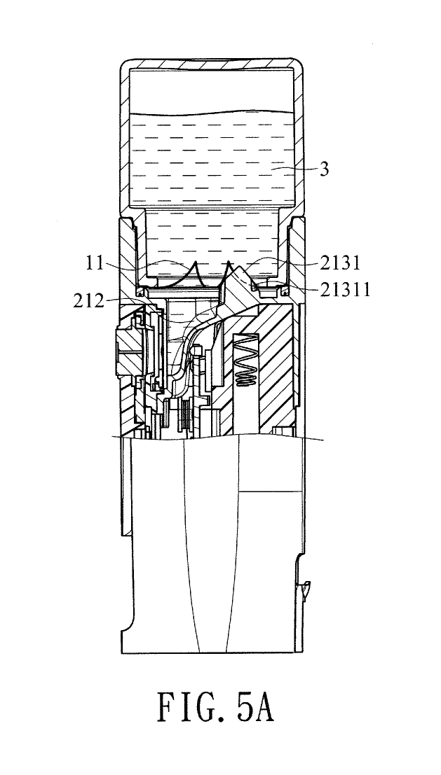

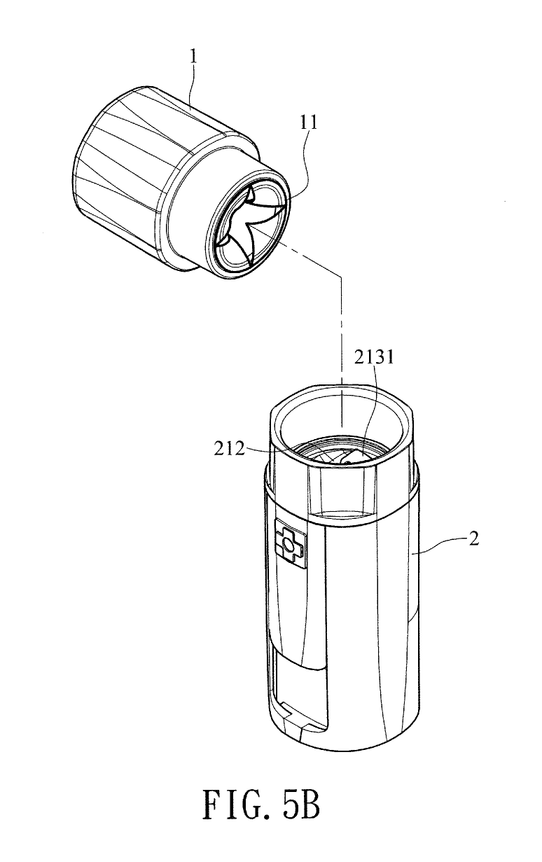

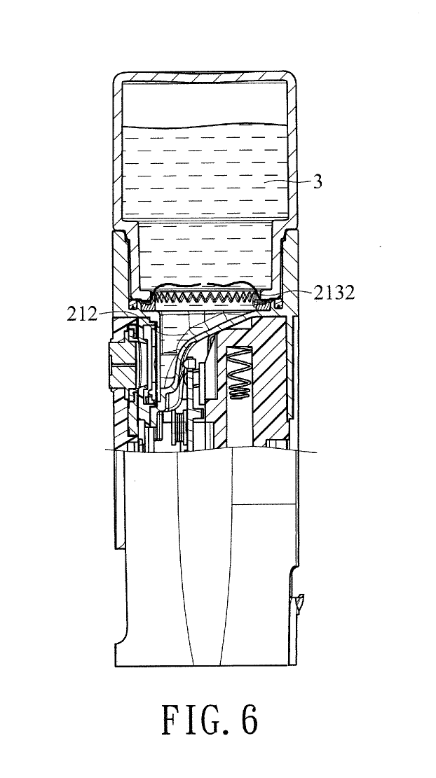

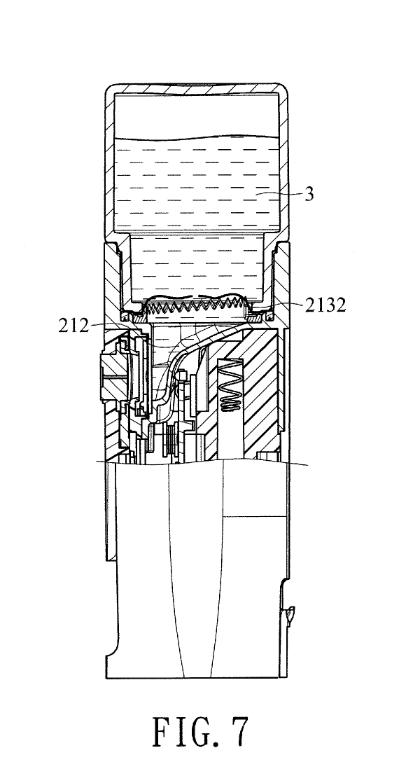

With reference to FIGS. 4, 5A, 5B, 6 and 7 for other implementation modes of a preferred embodiment of the present invention, FIGS. 4 and 1 show that the cut portion 2132 has 4 pointed teeth arranged adjacent to one another with an interval apart and disposed at four quartiles of the ring-shaped structure respectively. In addition, the push rod 2131 or the cut portion 2132 of the present invention can be installed separately in the installing slot 212 as shown in FIG. 5. In other words, the push rod 2131 is designed and installed in the installing slot 212 to facilitate destructing the seal 11 (which is a sealing film in this preferred embodiment), and a tip of the push rod 2131 is substantially in a sharp cone shape, and a surface of the sharp cone has a plurality of channels 21311 for bursting or propping open the seal 11 (wherein the seal 11 of this preferred embodiment is burst, but the invention is not limited to such arrangement only), and the supplementary liquid 3 flows through the channels 21311 into the installing slot 212. In FIG. 6, the cut portion 2132 is designed in the installing slot 212, and the cut portion 2132 has a plurality of pointed teeth with equal heights, or the pointed teeth of the cut portion 2132 as shown in FIG. 7 have unequal heights wherein the heights are increasingly higher, and the increasing higher pointed teeth are provided for facilitating the cutting of the seal 11 by abutting the seal 11 (which is a sealing film in this preferred embodiment), so as to achieve the effect of cutting open the seal 11 more smoothly. The foregoing two implementation modes destruct the seal 11 by cutting in order to allow the supplementary liquid to flow into the installing slot.

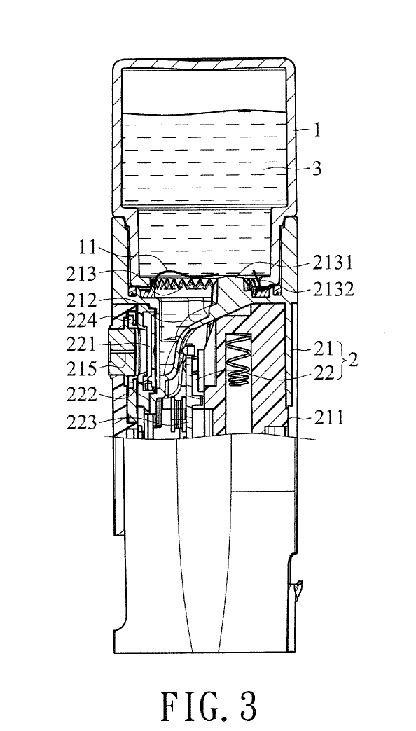

In FIG. 3, when the container 1 is combined with the atomizer 2 for use, an opening of the container 2 is aligned precisely with the installing slot 212 for the installation, and the seal destruction structure 213 is provided for destructing the seal 11 by bursting, cutting open or a combination of both to allow the supplementary liquid 3 to flow into the installing slot 212 and provide the supplementary liquid 3 for atomization and use by the atomization device 22.

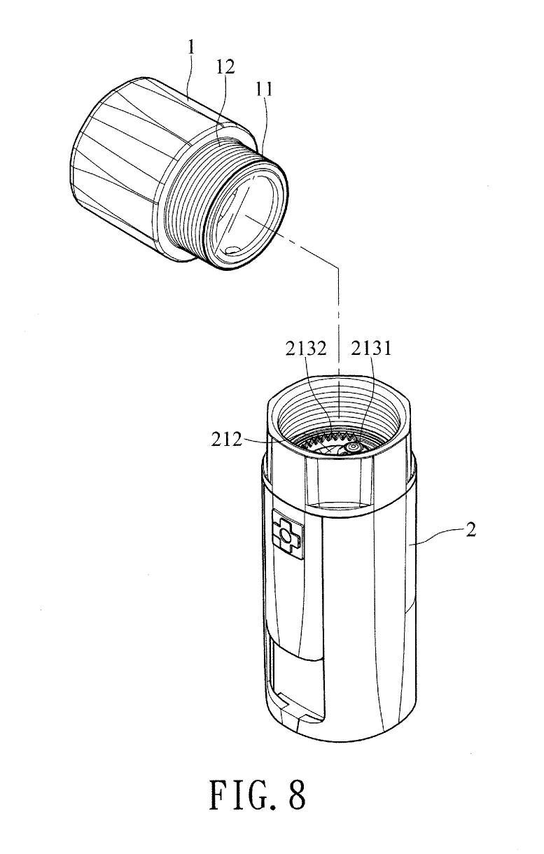

To facilitate the process of combining and assembling the container 1 and the atomizer 2 and prevent then from being loosened easily, the present invention further provides the following types of fixing structure installed onto the container and the atomizer 2. FIGS. 8, 9 and 10 are schematic views that show various different fixing structures of a preferred embodiment of the present invention.

In FIG. 8, a first thread portion 12 is disposed outside the container 1, and a second thread portion 23 is disposed on an internal wall of the installing slot 212 of the atomizer 2, so that the container 1 is installed in the installing slot 212 by a screwing method, and the rotation produced in the screwing process together with the push rod 2131 burst the seal 11 (which is a sealing film in this preferred embodiment, and the cut-off portion 2132 cut the seal 11 through the opening of the container 1, so that the supplementary liquid 3 (not shown in the figure) can flow into the installing slot 212.

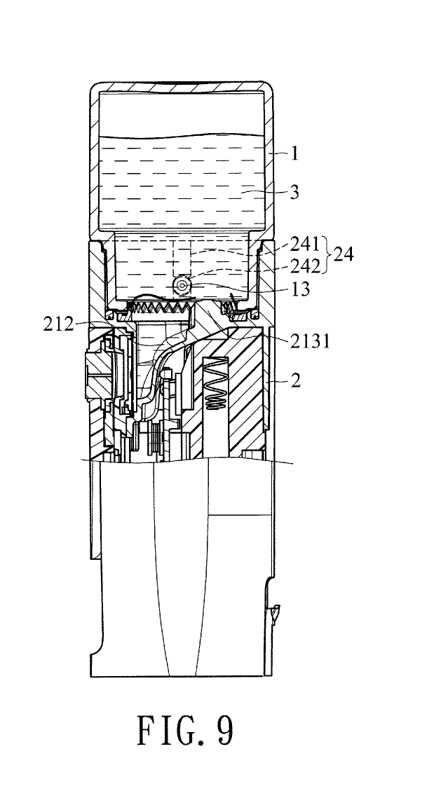

In FIG. 9, a pair of latches 13 are disposed outside the container 1 and symmetrically installed on an external wall of an opening of the container 1, and a pair of latching portions 24 are disposed on an internal wall of the installing slot 212 of the atomizer 2 and each latching portion 24 has a guide slot 241 corresponding to a protrusion 242 of each latch 13, so that when the latches 13 and the latching portions 24 are assembled, the latches 13 are slidably inserted into the guide slots 241 of the latching portions 24 respectively, and then the protrusions 242 latch the latches 13 at positions inside the guide slot 241, and such linear sliding method is more suitable for the design with only the push rod 2131 as shown in FIG. 5 to burst the seal 11 (which is a sealing film in this preferred embodiment) to allow the supplementary liquid 3 to flow into the installing slot 212.

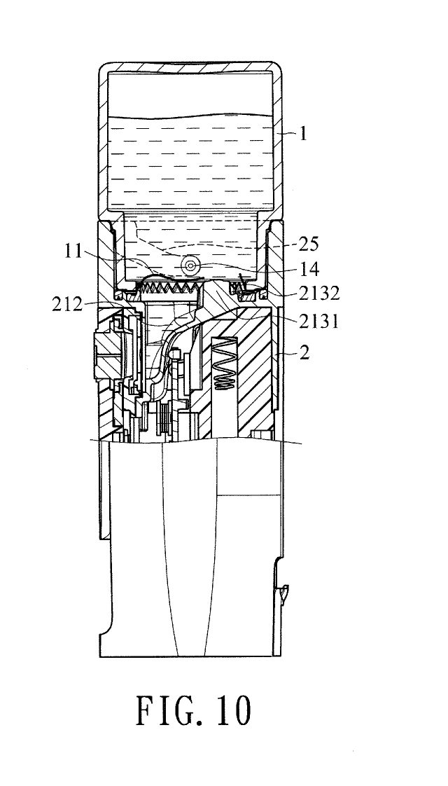

In FIG. 10, a pair of bumps 14 are formed outside the container 1 and symmetrically arranged at the opening of the container 1, and a pair of arc-shaped guide slots 25 are formed on an internal wall of the installing slot 212 of the atomizer 2, and the arc-shaped guide slot 25 is extended downwardly from a side and an end of the arc-shaped guide slot 25 has a size corresponding to the pair of bumps to provide a way of fixing the assembly. When the container 1 and the atomizer are assembled, the pair of bumps 14 are slidably rotated in a direction along the pair of arc-shaped guide slots 25 and operated together with the push rod 2131 to burst the seal 11 (which is a sealing film in this preferred embodiment the seal 11, and the cut-off portion 2132 cuts open the opening of the container 1 to allow the supplementary liquid 3 (not shown in the figure) to flow into the installing slot 212.

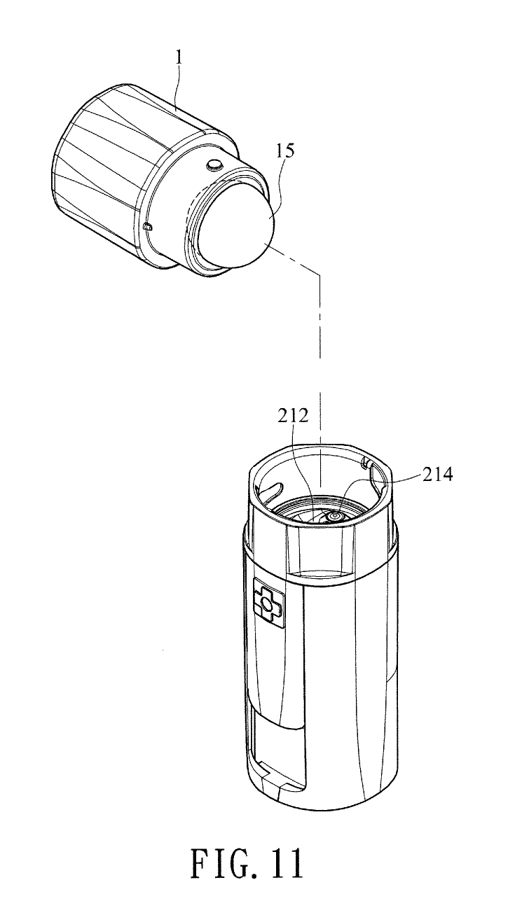

With reference to FIG. 11 for a schematic view of another sealing method of a preferred embodiment of the present invention, the container 1 is filled with a supplementary liquid 3 (not labeled in the figure), and a sphere 15 is installed at an opening of the container 1, wherein the sphere 15 is a common glass bead used for sealing the opening of the container 1 to prevent the supplementary liquid 3 from flowing out. In addition, a seal destruction structure 214 is installed in the installing slot 212 of the container 1, wherein the seal destruction structure 214 has a similar structure as the push rod 2131, such that when the container 1 is installed in the installing slot 212, the seal destruction structure 214 props open the sphere 15 and drops the sphere 15 into the container 1 to break the seal 11 and squeeze the supplementary liquid 3 to flow into the installing slot 212.

In summation of the description above, the disposable liquid supplement container 1 and the atomizer 2 of the present invention adopts different designs of the seal destruction structures 213, 214 to destruct the seal 11 of the container 1 by bursting, cutting, propping open or a combination of the above to allow the supplementary liquid 3 to flow into the atomizer 2 successfully for atomization and use, and the operation is very convenient. In addition, the container 1 comes with a disposable design and has the advantages of easy storage and convenient carry, and the container and the atomizer 2 are screwed or latched, so that they can be fixed by the rotation or pushing to prevent them from being loosened or falling apart easily.

What is claimed is:

1. An atomizer with a liquid supplement container, characterized in that the liquid supplement container is filled with a supplementary liquid, and has a seal disposed at an opening of the liquid supplement container; and
the atomizer, comprises:
a casing, having a containing space defined therein, at least one installing slot formed on the casing and interconnected with the containing space, and a seal destruction structure installed in the installing slot; and
an atomization device, installed in the containing space of the casing, and having at least one spray hole formed on a surface of the casing for atomizing the supplementary liquid and spraying the supplementary liquid out from the spray hole;
thereby, when the liquid supplement container is installed in the installing slot, the seal destruction structure is provided for destructing the seal, so that the supplementary liquid flows into the installing slot for an atomization by the atomization device.

2. The atomizer with a liquid supplement container according to claim 1, wherein the container is made of a material selected from the collection of glass, plastic and metal, and the seal is one selected from the collection of a sealing film, a slab, and a sphere, and the seal is made of a material selected from the collection of paper, metal, silicone and plastic.

3. The atomizer with a liquid supplement container according to claim 1, wherein the seal destruction structure includes at least one push rod, at least one cut portion or a combination thereof.

4. The atomizer with a liquid supplement container according to claim 3, wherein the push rod is installed at a center position or a bias position of the installing slot for bursting or propping open the seal.

5. The atomizer with a liquid supplement container according to claim 3, wherein the cut portion has a plurality of pointed teeth arranged discontinuously and with an interval apart from one another.

6. The atomizer with a liquid supplement container according to claim 3, wherein the cut portion has a plurality of pointed teeth arranged adjacent to one another to form a ring-shaped structure.

7. The atomizer with a liquid supplement container according to claim 3, wherein the cut portion is integrally formed in the installing slot.

8. The atomizer with a liquid supplement container according to claim 3, wherein the seal destruction structure destructs the seal by bursting or cutting or a combination thereof, if the seal is a sealing film.

9. The atomizer with a liquid supplement container according to claim 8, wherein the seal has at least one pair of pre-cut lines formed thereon, intersected with one another, and provided for the push rod to burst the seal.

10. The atomizer with a liquid supplement container according to claim 3, wherein if the seal is a sphere, the seal destruction structure is the push rod for destructing the seal in a sealed status by a propping open method.

11. The atomizer with a liquid supplement container according to claim 1, wherein the container has a first thread portion disposed outside the container and provided for screwing to a second thread portion of the installing slot internal wall.

12. The atomizer with a liquid supplement container according to claim 1, wherein the container has at least one pair of latches disposed outside the container for latching into internal walls of at least one pair of latching portions of the installing slot.

13. The atomizer with a liquid supplement container according to claim 12, wherein each latching portion has a guide slot disposed at a position corresponding to each respective latch, and provided for latching a protrusion of the latch therein.

14. The atomizer with a liquid supplement container according to claim 1, wherein the container has at least one pair of bumps disposed outside the container for slidably latching into at least one pair of arc-shaped guide slots formed on an internal wall of the installing slot.

15. The atomizer with a liquid supplement container according to claim 1, wherein the atomization device includes a spray-hole plate, a piezoelectric plate and a driving circuit board, and the spray-hole plate is installed in the containing space, and the piezoelectric plate is disposed on the spray-hole plate, and the driving circuit board is electrically coupled to the piezoelectric plate for driving an operation of the piezoelectric plate.
